(19) United States
(12) Patent Application Publication
(10) Pub. No.: US 2014/0286848 A1
(43) Pub. Date: Sep. 25, 2014

(54) Reactor Design for Reacting Organochlorosilanes and Silicon Tetrachloride to Obtain Hydrogen-Containing Chlorosilanes

(71) Applicants: Yücel Önal, Carl Junction, MO (US); Guido Stochniol, Haltern am See (DE); Jörg Sauer, Karlsruhe (DE); Ingo Pauli, Schmitten (DE); Norbert Schladerbeck, Kelkheim (DE)

(72) Inventors: Yücel Önal, Carl Junction, MO (US); Guido Stochniol, Haltern am See (DE); Jörg Sauer, Karlsruhe (DE); Ingo Pauli, Schmitten (DE); Norbert Schladerbeck, Kelkheim (DE)

(73) Assignee: Evonik Degussa GmbH, Essen (DE)

(21) Appl. No.: 14/005,413

(22) PCT Filed: Jan. 27, 2012
(86) PCT No.: PCT/EP2012/051329

§ 371 Date: Apr. 16, 2014

(30) Foreign Application Priority Data
Mar. 16, 2011 (DE) 102011005643.2

(51) Int. Cl. C01B 33/107

(52) U.S. Cl. CPC C01B 33/10747
USPC 423/342

(57) ABSTRACT

The invention relates to a process for producing hydrogen-containing chlorosilanes by reducing Si-based deposits of solid material during the operation of a pressurised reactor comprising one or more reaction spaces, wherein at least one organochlorosilane is reacted with hydrogen in at least one of these reaction spaces for at least some of the time, characterized in that at least one of the optionally two or more reaction spaces in which this reaction takes place is supplied with additional HCl for at least some of the time. The additional HCl is preferably produced by hydrodehalogenation of silicon tetrachloride with hydrogen in at least one of the optionally two or more reaction spaces of the reactor.

The invention relates to a process for producing hydrogen-containing chlorosilanes by reducing Si-based deposits of solid material during the operation of a pressurised reactor comprising one or more reaction spaces, wherein at least one organochlorosilane is reacted with hydrogen in at least one of these reaction spaces for at least some of the time, characterized in that at least one of the optionally two or more reaction spaces in which this reaction takes place is supplied with additional HCl for at least some of the time. The additional HCl is preferably produced by hydrodehalogenation of silicon tetrachloride with hydrogen in at least one of the optionally two or more reaction spaces of the reactor.

Hydrogen-containing chlorosilanes and more particularly trichlorosilane (TCS) are important raw materials for the production of the hyperpure silicon needed in the semiconductor and photovoltaics industry. The demand for TCS has risen continuously in recent years and is forecast to continue to rise for the foreseeable future.

Hyperpure silicon is produced from TCS by chemical vapour deposition (CVD) by the industrially standard Siemens process. The TCS used is typically obtained by a chlorosilane process, i.e. reaction of crude silicon with HCl at temperatures around 300° C. in a fluidised bed reactor, or at temperatures around 1000° C. in a fixed bed reactor and subsequent distillative workup of the product mixture.

Depending on the choice of process parameters, both the CVD process of hyperpure silicon production and the chlorosilane process can generate major quantities of silicon tetrachloride (STC) as coproduct. To enhance the economics of the above processes and in order that the rising demand for TCS may be satisfied, various processes have been developed for transforming STC into TCS.

The standard industrial approach is to use a thermally controlled process for hydrodehalogenation of STC to TCS, wherein the STC is passed together with hydrogen into a graphite-lined reactor and reacted at temperatures of 1100° C. or higher. The high temperature and the presence of hydrogen cause the equilibrium to shift in the direction of the TCS product. After the reaction, the product mixture is discharged from the reactor and separated off in costly and inconvenient processes.

Process improvements suggested here in recent years include more particularly, as elaborated in U.S. Pat. No. 5,906,799 for example, the use of carbon-based materials with a chemically inert coating, of SiC say, for lining the reactor. In this way, degradation of the construction material and contamination of the product gas mixture due to reactions of the carbon-based material with the chlorosilane/H₂ gas mixture can be largely avoided.

DE 102005046703 A1 describes the in situ SiC coating of a graphitic heating element in a step preceding hydrodehalogenation. Disposing the heating element in the interior of the reaction chamber increases the efficiency of energy input from the electric resistance heating.

Yet the above processes are disadvantageous in that costly and inconvenient coating processes are required in some instances. Moreover, the heat needed for the reaction to proceed has to be supplied by electrical resistance heating because of the use of carbon-based construction materials, which is uneconomical compared with direct heating using natural gas. In addition, the required high reaction temperatures of typically 1000° C. or higher give rise to undesired deposits of silicon, which necessitate regular cleaning of the reactor.

The essential disadvantage, however, is the fact that the reaction is carried out purely thermally, without a catalyst, making the above processes altogether very inefficient. Accordingly, various processes have been developed for catalytic hydrodehalogenation of STC.

A commonly assigned earlier application describes a process for hydrodehalogenation of SiCl₄ to TCS. In this process, the reaction advantageously takes place under superatmospheric pressure and in the presence of a catalyst comprising at least one active component selected from the metals Ti, Zr, Hf, Ni, Pd, Pt, Mo, W, Nb, Ta, Ba, Sr, Ca, Mg, Ru, Rh, Ir or combinations thereof or silicide compounds thereof. This method provides high space-time yields of TCS with a virtually thermodynamic degree of conversion and high selectivity. The reactor used in the process contains one or more reactor tubes consisting of gastight ceramic material and preferably coated with the catalyst. More particularly, reactor tubes consisting of SiC, Si₃N₄ or hybrid systems thereof are used because they are sufficiently inert, corrosion-resistant and gastight even at the high required reaction temperatures around 900° C. Owing to this choice of material, the heat for the reaction can be supplied economically by disposing the reactor tubes in a combustion chamber heated by burning natural gas.

Besides STC, further coproducts generated in the course of the CVD process of hyperpure silicon production and also in the course of the chlorosilane process, as a result of reaction with organic impurities, are organochlorosilanes (OCS) such as methyldichlorosilane (MHDCS), methyltrichlorosilane (MTCS) or propyltrichlorosilane (PTCS). Organochlorosilanes can also be produced specifically by Müller-Rochow synthesis from silicon and alkyl chlorides.

In view of the rising demand for TCS and hyperpure silicon, it would be economically very attractive to exploit these sources of organochlorosilanes, more particularly MTCS as sidestream of a Müller-Rochow synthesis, for the semiconductor and photovoltaics industry. There is accordingly a need for an efficient process for converting OCS into hydrogen-containing chlorosilanes, more particularly TCS.

A commonly assigned parallel application describes a process for conversion of MTCS and also PTCS into a chlorosilane mixture comprising dichlorosilane (DCS), TCS and STC under process conditions as typically also needed for hydrodechlorination of STC to TCS. Methane CH₄, HCl and MHDCS are formed in the course of the process as further by-products. However, significant conversions with regard to MTCS are only obtained at a temperature of 800° C. or higher. These high temperatures have an unwanted side-effect in leading to the deposition of solid materials consisting essentially of silicon. The deposition of Si-based solid materials constitutes lost raw material, promotes the degradation of the materials of construction of the reaction spaces of the reactor, and requires the reactor to be shut down at regular intervals to allow for mechanical removal of deposits. In addition, excessively high pressure drops can in the worst case require an unscheduled shutdown of the reactor.

The problem addressed by the present invention was therefore that of providing an economical process for hydrogenation of organochlorosilanes to hydrogen-containing chlorosilanes which provides a high space-time yield and selectivity with regard to TCS and, more particularly, prevents or at least reduces noticeable deposits of solid materials to ensure an efficient continuous reactor operation.

To solve this problem, it was found that the deposition of Si-based solid material from the reaction of OCS with hydrogen to form hydrogen-containing chlorosilanes can be at least partly reversed by treatment with additional HCl under reaction conditions typical for the conversion of STC- and/or OCS-containing gases or gas mixtures. It was determined that the amount of Si-based deposits of solid material can be distinctly reduced in continuous reactor operation if at least one reaction space of the reactor in which the reaction of one or more organic chlorosilanes with hydrogen is carried out for at least some of the time is exposed to additional HCl under the established reaction conditions for at least some of the time.

The term “additional HCl” is to be understood in the context of the present invention as meaning that the HCl in question is not HCl by-produced in the course of the reaction of the at least one organic chlorosilane with hydrogen, but HCl which is supplied to the reactor in pure form or as HCl-containing gas mixture, or HCl which is produced in the reactor by a chemical reaction other than the hydrogenation of organochlorosilanes.

Without wishing to be tied to any one particular theory, the inventors believe that the additional HCl favours the hydrochlorination reaction of the silicon in the solid deposits to form chlorosilanes and more particularly hydrogen-containing chlorosilanes. This can accordingly not only serve to regenerate the reactor by removing the solid deposits during operation but advantageously also to enhance the yield of hydrogen-containing chlorosilanes.

It will prove particularly advantageous to produce the additional HCl by hydrodehalogenation of silicon tetrachloride with hydrogen in the reactor. For this, silicon tetrachloride and hydrogen are passed into the reactor and reacted at a reaction temperature of typically 700° C. or higher. The HCl liberated in the course of this reaction is consumed by the abovementioned reaction with silicon to form chlorosilanes and particularly hydrogen-containing chlorosilanes. This in turn removes HCl from the thermodynamic equilibrium of the hydrodehalogenation of STC, so that the resulting shift in equilibrium also serves to distinctly increase the yield of hydrogen-containing chlorosilanes and particularly TCS, which are formed by hydrodehalogenation of STC.

The present invention is based in this aspect on the reactor concept of the abovementioned commonly assigned earlier patent application for a process for production of TCS by catalytic hydrodehalogenation of STC. It makes it possible, given a suitable choice of reaction parameters such as temperature, pressure, residence time and amount of substance ratios for the starting materials, to provide an efficient process for hydrogenating OCS to hydrogen-containing chlorosilanes with high space-time yield and selectivity with regard to TCS. The option of an economical input of heat by disposing the gastight ceramic reactor tubes as reaction spaces in a heating chamber fired with combustible gas represents a further advantage of the process.

The possibility of combining the hydrogenation of organochlorosilanes with the hydrodehalogenation of STC to TCS in one or more conjoint or separate reaction spaces of the reactor represents a special feature of the process according to the present invention whereby, as explained above, a reduction in solid deposits in the reactor and an increase in the yield of TCS are achieved. Various reactor interconnections and operation methods serving to reduce the deposits of Si-based solid material are exemplified hereinbelow in the course of the description of the invention solution to the abovementioned problem including preferred modes of performance.

The invention provides a process for producing hydrogen-containing chlorosilanes in a pressurised reactor comprising one or more reaction spaces, wherein at least one organochlorosilane is reacted with hydrogen in at least one of these reaction spaces for at least part of the time, characterized in that at least one of the optionally two or more reaction spaces in which this reaction takes place is supplied with additional HCl for at least part of the time.

The present invention more particularly provides a process for reducing Si-based deposits of solid material in the production of hydrogen-containing chlorosilanes as per the process according to the present invention, characterized in that the reducing of Si-based deposits of solid material is effected during the operation of the pressurised reactor.

The one or more reaction spaces of the reactor may each consist of a reactor tube composed of gastight ceramic material. This gastight ceramic material may preferably be selected from SiC, so-called nitrogen-bonded SiC (NSiC), Si₃N₄ or hybrid systems (SiCN) thereof. Optionally, at least one reactor tube may be packed with packing elements composed of the same material.

The additional HCl can be supplied to the reactor in pure form or as HCl-containing gas mixture, or the supply of additional HCl can be effected by producing the additional HCl in the reactor by a chemical reaction other than the hydrogenation of organochlorosilanes.

It is particularly preferable for the chemical reaction producing the additional HCl to be a hydrodehalogenation of silicon tetrachloride with hydrogen, which takes place in at least one of the optionally two or more reaction spaces of the reactor. For this, silicon tetrachloride-containing feed gas and hydrogen-containing feed gas may be passed into the reactor where this mixture is exposed to high reaction temperatures of 700° C. or higher, typical for the hydrodehalogenation of STC to TCS, for conversion. The exemplary embodiments hereinbelow of possible reactor interconnections illustrate that the reaction of STC with hydrogen can be carried out at the same time as the hydrogenation of organic chlorosilanes in one or more conjoint reaction spaces or else spatially separately, in different reaction spaces of the reactor.

A feature common to all variants of the process according to the present invention is that the at least one organochlorosilane as organochlorosilane-containing feed gas and/or the hydrogen as hydrogen-containing feed gas and/or the additional HCl can be fed as pressurised streams into one or more reaction spaces of the reactor and reacted therein, by supply of heat, to form at least one product gas mixture containing hydrogen-containing chlorosilanes, and the product gas mixture can be led out of the reactor as a pressurised stream.

The process of the present invention may utilise organochlorosilanes of the formula RₓSiCl₄₋ₓ where x=1, 2, 3 or 4 and R may be an alkyl group, especially of 1 to 8 carbon atoms, a phenyl group or an aralkyl group. The organic groups R may be unsubstituted or substituted one or more times, in which case the substituents may be, for example, halogen, hydroxyl, ether, keto, carbonyl, carboxyl, ester, amino, amide and/or thiol groups. When two or more organic moieties R are present, these may be identical to or different from each other. Preference is given more particularly to alkyltrichlorosilanes, i.e. compounds of the formula RSiCl₃, where R is as defined above, the reaction of which with hydrogen gives high yields of the desired product, TCS. The process of the present invention can further also be used for hydrogenation of organically substituted disilanes or higher silanes. However, the product mixture will in these cases include only a relatively small proportion of TCS.

It is particularly preferable for the at least one organochlorosilane in the process of the present invention to be selected from the group comprising methyltrichlorosilane (MTCS), methyldichlorosilane (MHDCS), propyltrichlorosilane (PTCS), ethyltrichlorosilane (ETCS) and mixtures thereof.

In a very particularly preferred embodiment of the process according to the present invention, methyltrichlorosilane is used as organochlorosilane. In this case, the proportion of the organochlorosilane-containing feed gas used that is accounted for by methyltrichlorosilane preferably amounts to at least 97% by weight; total impurities should thus account for not more than 3% by weight.

The gastight ceramic material of which the reactor tubes consist is preferably selected from SiC, Si₃N₄ or hybrid systems (SiCN) thereof. Particular preference is given to SSiC (pressureless sintered SiC) or so-called nitrogen-bonded SiC (NSiC) and also silicon carbonitride (SiCN). These are pressure stable even at high temperatures, so that the TCS synthesis from organic chlorosilanes and/or STC can be run at several bar of pressure. They are further sufficiently corrosion-resistant even at the necessary reaction temperatures of above 700° C. In a further embodiment, the materials of construction mentioned can have a thin coating of SiO₂ in the μm range as an additional corrosion control layer.

In a specific embodiment of the process according to the invention, at least one reactor tube can be packed with packing elements consisting of the same gastight ceramic material as the tube. This inert unstructured packing material may be used to optimise flow dynamics. By way of unstructured packing material, packing elements such as rings, balls, rods or other suitable packing elements can be used.

In a particularly preferred embodiment of the process according to the present invention, the inside walls of at least one reactor tube and/or at least some of the packing elements have a coating with at least one material catalysing the reaction of organochlorosilane(s) with H₂ to form hydrogen-containing chlorosilanes. In effect, the material of the coating should preferably also catalyse the hydrodehalogenation of STC with H₂ to form TCS. In general, the tubes can be used with or without catalyst, although the catalytically coated tubes constitute a preferred embodiment since suitable catalysts lead to an increased rate of reaction and thus to an increased space-time yield. When the packing elements are given a catalytically active coating, it may be possible to dispense with the catalytically active internal coating of the reactor tubes, if desired. However, even in this case it is preferable for the inside walls of the reactor tubes to be included in the coating, since this enlarges the catalytically useful surface area compared with purely supported catalyst systems (in the form of a fixed bed for example).

The catalytically active coating(s), i.e. for the inside walls of the reactor tubes and/or an optionally used fixed bed, preferably consist of a composition comprising at least one active component selected from the metals Ti, Zr, Hf, Ni, Pd, Pt, Mo, W, Nb, Ta, Ba, Sr, Ca, Mg, Ru, Rh, Ir or combinations thereof or silicide compounds thereof, insofar as these exist. In addition to the at least one active component, the composition frequently contains in addition one or more suspension media and/or one or more auxiliary components, particularly for stabilizing the suspension, for improving the storage stability of the suspension, for improving the adherence of the suspension to the surface to be coated and/or for improving the application of the suspension to the surface to be coated. Application of the catalytically active coating to the inside walls of the reactor tubes and/or to the optionally used fixed bed can be effected by applying the suspension to the inside walls of the one or more reactor tubes and/or to the surface of the packing elements, drying the applied suspension and subsequent heat treatment at a temperature in the range from 500° C. to 1500° C. under inert gas or hydrogen.

The at least one reaction tube is typically disposed in a heating chamber. The heat needed to conduct the reaction can be introduced by electrical resistance heating or by burning a fuel gas, such as natural gas, in the heating chamber. Advantages of using systems heated by fuel gas include uniform temperature control and more economical operation. In order that local temperature spikes in the reactor tubes may be avoided when heating with a fuel gas, the burners should not point directly at the tubes. For instance, they can be distributed throughout the heating chamber and directed such that they point into the free space between parallel reactor tubes.

To enhance energy efficiency, the reactor system can further be connected to a heat recovery system. In one particular embodiment, one or more reactor tubes are sealed at one end for this purpose and each contain a gas-feeding interior tube which preferably consists of the same material as the reactor tubes. Flow reversal occurs here between the sealed end of a particular reactor tube and the interiorly lying tube's opening facing this sealed end. In this arrangement, the ceramic interior tube transfers heat from product gas mixture flowing between reactor tube inside wall and interior tube outside wall to feed gas streaming in through the interior tube. The integrated heat-exchange tube may also have an at least partial coating with the catalytically active material described above.

The conversion in the process of the present invention is typically carried out at a temperature in the range from 700° C. to 1000° C. and preferably in the range from 850° C. to 950° C. and/or a pressure in the range from 1 to 10 bar, preferably in the range from 3 to 8 bar and more preferably in the range from 4 to 6 bar, and/or in a gas stream in the range from 0.1 to 10 s and preferably in the range from 1 to 5 s.

Some reactor interconnections and operating methods will now be described to more particularly elucidate the process of the present invention by way of example.

In one specific embodiment of the process according to the present invention, at least one, optionally every, reaction space is supplied alternatingly with a) the additional HCl and b) the organochlorosilane in admixture with the hydrogen.

The additional HCl on the one hand and the organochlorosilane in admixture with the hydrogen on the other are fed simultaneously to separate reaction spaces, in a preferred embodiment.

The switches between the feed of a) additional HCl and b) the organosilane in admixture with the hydrogen to the individual reaction spaces is preferably effected simultaneously for all reaction spaces, but can also be done independently for each individual reaction space.

The times at which the switches between the feed of additional HCl on the one hand and the organochlorosilane in admixture with the hydrogen on the other to the at least one reaction space take place can be ascertained in particular as a function of pressure and/or mass balance changes measured in at least one reaction space.

These parameters can be suitable for indicating the formation of a significant amount of solid deposits or, conversely, the substantial removal of solid deposits formed in the reactor. Solid deposits in a reaction space can reduce the flow cross-section thereof and thus cause a pressure drop. Pressure can be measured according to any method known in the prior art, for example using suitable mechanical, capacitative, inductive or piezoresistive pressure meters. Substantial removal of Si-based solid deposits in a reaction space can be evident for example from an increased HCl concentration in the product gas mixture leaving this reaction space, since the consumption of HCl by the reaction with silicon is reduced by the decreasing availability of the latter. The composition of the product gas can be measured using known analytical techniques, for example gas chromatography combined with mass spectrometry.

The switches in charging the starting materials to the individual reaction spaces in the manner described above can be effected using a suitable customary control valve system.

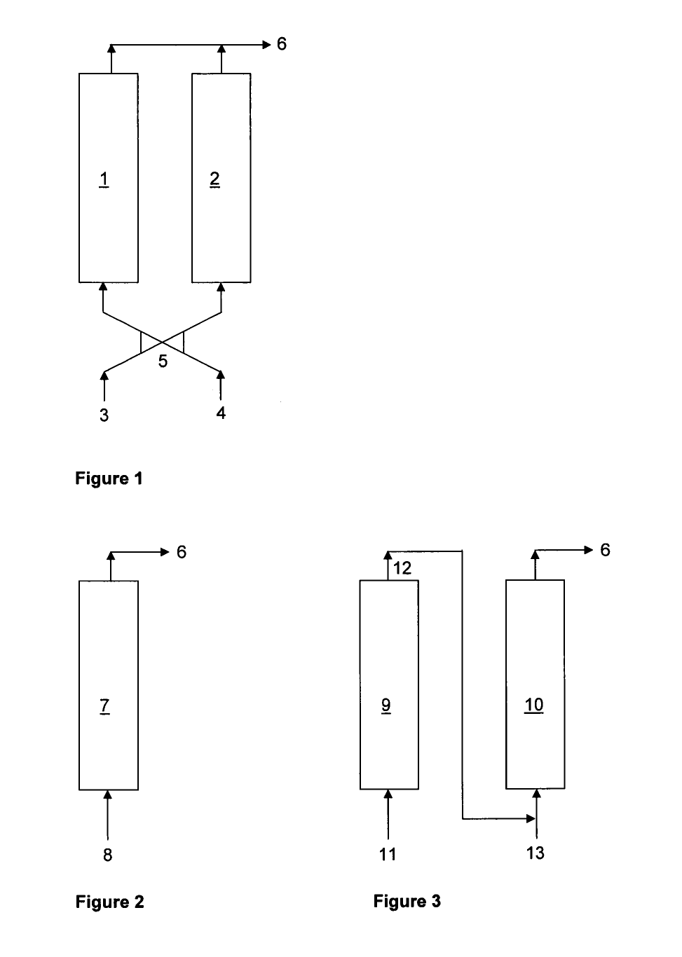

Above-described versions of performing the process of the present invention are illustrated by way of example in FIG. 1 for the case of two separate reaction spaces which are each supplied alternatingly with additional HCl on the one hand and OCS admixed with H₂ on the other, with one reaction space at a time being supplied with additional HCl while the other reaction space is supplied with OCS admixed with H₂.

For instance, the reaction of OCS with H₂ and a hydrodehalogenation of STC with H₂, which produces additional HCl, can take place in two separate reaction spaces (reaction space 1 and reaction space 2). The product gas streams are collected and sent to be worked up. Initially, the reaction of OCS with hydrogen and the hydrodehalogenation of STC in the presence of hydrogen can be carried out in reaction space 1 and in reaction space 2 respectively, until a significant deposition of solid material takes place in reaction space 1. This would be discernible for example from the pressure drop and also the material balance on the reactor. Subsequently, the feed of the starting materials to the individual reaction spaces is switched by feeding STC and H₂ to reaction space 1 and OCS and H₂ to reaction space 2, so that it will be the hydrodehalogenation of STC taking place in reaction space 1 and the hydrogenation of OCS in reaction space 2. The HCl coproduced in the course of the hydrodehalogenation of STC then gradually removes the solid silicon deposited in reaction space 1 before the change of feed to form chlorosilanes and more particularly hydrogen-containing chlorosilanes, and thereby regenerates the reactor. After at least partial removal of the solid deposits in reaction space 1 and/or significant formation of solid material in reaction space 2, the feeds to the individual reaction spaces should be switched back into the original configuration, so that the regeneration of reaction space 2 can start. The alternating switch in feed to OCS on the one hand and STC on the other to reaction spaces 1 and 2 thus provides for a continuous and stable operation of the reactor.

The molar ratio of hydrogen to total organochlorosilane(s) must be set in the range from 1:1 to 8:1 and preferably in the range from 2:1 to 6:1 in charging the reaction spaces. The molar ratio of hydrogen to silicon tetrachloride here must be set such that it is in the range from 1:1 to 8:1 and preferably in the range from 2:1 to 6:1.

In a further method of reactor operation according to the invention, the additional HCl, the organochlorosilane and the hydrogen are fed simultaneously to one or more conjoint reaction spaces. In the simplest case, the reaction takes place in a single conjoint reaction space, as shown in FIG. 2 by way of example.

When the additional HCl is produced by hydrodehalogenation reaction of silicon tetrachloride and hydrogen, the method of operation described above requires that not only OCS, STC and hydrogen be fed in a certain amount of substance ratio to the at least one conjoint reaction space. This requires setting the molar ratio of silicon tetrachloride to total organochlorosilanes in the range from 50:1 to 1:1 and preferably in the range from 20:1 to 2:1, the molar ratio of silicon tetrachloride to hydrogen in the range from 1:1 to 8:1 and preferably in the range from 2:1 to 6:1 and the molar ratio of total organochlorosilanes to hydrogen in the range from 1:1 to 8:1 and preferably in the range from 2:1 to 6:1. Constant removal of the Si deposited in conversion of OCS by the HCl formed at the same time in the same reaction space in the course of hydrodehalogenation serves to ensure sustained stable operation.

In a further reactor interconnection of the process according to the present invention, the additional HCl can be fed to at least one first reaction space and the organochlorosilane, optionally in admixture with the hydrogen, to at least one second reaction space, wherein the product gas mixture leaving the at least one first reaction space is additionally fed to the at least one second reaction space. The feeding of additional HCl to the at least one first reaction space here is effected more particularly by forming the additional HCl by hydrodehalogenation reaction of STC with H₂ in the at least one first reaction space.

For example, as illustrated in FIG. 3, there can be two separate reaction spaces 1 and 2 which are fed with starting materials for reaction by feeding STC and H₂ to reaction space 1 and OCS and H₂ to reaction space 2. The product gas mixture from reaction space 1, containing STC, TCS, DCS, H₂ and also HCl, is led into the OCS/H₂ stream prior to its entry into reaction space 2. Silicon deposited as intermediate in reaction space 2 in the course of the hydrogenation of organochlorosilanes is subsequently removed again by the HCl-containing product gas stream from reaction space 1 to thereby sustain stable operation of the reactor.

With the reactor interconnection as above, the hydrogen needed for the reactions can also be fed to the reactor together with STC only, via the at least one first reaction space. The at least one second reaction space can then be fed with an OCS stream to which the product gas mixture from the at least one first reaction space is added. Hydrogen in said product gas mixture as a result of being unconverted in the at least one first reaction space can then react with OCS in the at least one second reaction space. It is preferable, however, for hydrogen to be fed to the reactor not only together with STC, feeding the at least one first reaction space, but also together with OCS, feeding the at least one second reaction space. This allows a more independent setting of advantageous amount of substance ratios for the hydrodehalogenation of STC in the first reaction space and for the hydrogenation of OCS in the second reaction space.

The molar ratio of H₂ to STC shall preferably be set in the range from 1:1 to 8:1 and more preferably in the range from 2:1 to 6:1 for the reaction in the at least one first reaction space. The molar ratio of hydrogen to total OCS for the reaction in the at least one second reaction space must be set such that it is in the range from 1:1 to 8:1 and preferably in the range from 2:1 to 6:1.

A feature common to all variants of the process according to the present invention is that the product gas streams are typically sent to a further processing stage or to a workup stage.

The product gas mixture can be worked up according to methods known in the prior art. Workup may include for example steps for condensation, distillation, extraction, selective adsorption and/or absorption and/or washing steps and/or chemical reactions in order that the components present in the product gas mixture may be isolated in as pure a form as possible.

Further processing can more particularly take place in an Si-based integrated system, in which case for example recovered TCS can be sent to a component plant for production of hyperpure silicon by the Siemens process and HCl to a chlorosilane process.

FIG. 1 is an illustrative schematic of an inventive method of operating a reactor for production of hydrogen-containing chlorosilanes which comprises feeding OCS in admixture with hydrogen on the one hand and additional HCl on the other in a spatially separated manner to two reaction spaces in parallel connection.

FIG. 2 is an illustrative schematic of an inventive method of operating a reactor for production of hydrogen-containing chlorosilanes which comprises feeding OCS, hydrogen and additional HCl to a conjoint reaction space.

FIG. 3 is an illustrative schematic of an inventive method of operating a reactor for production of hydrogen-containing chlorosilanes which comprises feeding OCS optionally in admixture with H₂ on the one hand and also additional HCl in the form of STC and H₂, from which it is formed by hydrodehalogenation, on the other, to two reaction spaces connected in series wherein OCS with or without H₂ in spatial terms is only fed to the reactor after the first reaction space.

Turning to FIG. 1, the depicted method of operating the reactor comprises two separate reaction spaces 1,2 feeding in each case one of these reaction spaces with additional HCl via a first line 3 and which ever is the other reaction space with OCS admixed with H₂ via a second line 4 such that a control valve system 5 can be used to switch the feed of the materials mentioned to the individual reaction spaces. The product gas mixture from both the reaction spaces 1 and 2 is collected and sent via a line 6 to a further processing stage or to a workup stage.

Turning to FIG. 2, the depicted method of operating the reactor comprises feeding a single reaction space 7 with OCS, H₂ and additional HCl via a line 8 and the product gas mixture leaving the reaction space 7 via a line 6 to a further processing stage or to a workup stage.

Turning to FIG. 3, the depicted method of operating the reactor comprises two separate reaction spaces 9,10 feeding the first reaction space 9 with a mixture of STC and H₂ via a line 11, the product gas mixture leaving the first reaction space 9 and containing additional HCl via a line 12 into a stream of OCS, optionally in admixture with H₂, which is fed to the second reaction space 10 via a further line 13. The product gas mixture leaving the second reaction space 10 is sent via a line 6 to a further processing stage or to a workup stage.

The examples hereinbelow come from laboratory tests and prove the in-principle feasibility of the performance options described above. They are intended to more particularly elucidate the process of the invention, but not restrict it in any way.

### EXAMPLES

### Example 1

Making the Reactor

A. Making the Catalyst Paste:

A mixture of 54% by weight of toluene, 0.3% by weight of Aerosil R 974, 6.0% by weight of phenylethylpolysiloxane, 16/8% by weight of Reflaxal aluminium pigment, 10.7% by weight of Degalan LP 62/03 solution and 12.2% by weight of tungsten silicide was intensively mixed in a mixing vessel.

B. Coating an SiC Tube with the Catalyst Paste and Forming the Catalyst:

The recipe described above was used to coat a ceramic tube composed of silicon carbide (SSiC) by filling the catalyst mixture into the tube. The stoppered tube was shaken to distribute the mixture uniformly, before air-drying overnight. The tube used had an internal diameter of 15 mm and a length of 120 cm. The tube was mounted in an electrically heatable tubular oven. Initially, the tubular oven was brought to 900° C. while nitrogen at 3 bar absolute was passed through the reactor tube. After two hours, the nitrogen was replaced by hydrogen. After a further hour in the hydrogen stream under 3.6 bar absolute, catalyst formation was discontinued.

### Example 2

Hydrogenation of MTCS

MTCS conversion to chlorosilanes and more particularly hydrogen-containing chlorosilanes was carried out in the reactor described under Example 1. The MTCS stream was 100.6 g/h for an H₂:MTCS amount of substance ratio of 4:1. Total pressure was 3.7 bar absolute. The following MTCS conversions were observed as a function of oven temperature:

TABLE 1
Conversion of MTCS as function of oven temperature

| Oven temperature [° C.] | MTCS conversion [mol %] |
|---|---|
| 700 | 0.33 |
| 800 | 18.85 |
| 850 | 60.94 |
| 900 | 88.09 |
| 950 | 93.22 |

### Example 3

Product Composition in MTCS Conversion

The composition of the product gas mixture for the MTCS reaction with hydrogen at an oven temperature of 950° C. in Example 2 was analyzed using gas chromatography (GC). Calibration was done with corresponding pure substances. The following product composition based on the gas phase was determined:

TABLE 2
Conversion of MTCS and composition of product gas mixture for
reaction as per Example 2 at oven temperature of 950° C.

| | | |
|---|---|---|
| MTCS conversion | 93.2 | mol % |
| DCS | 1.7 | mol % |
| TCS | 23.4 | mol % |
| STC | 24.5 | mol % |
| MHDCS | 0.5 | mol % |
| HCl | 2.8 | mol % |
| CH₄ | 49.2 | mol % |

### Example 4

Solid Deposit After MTCS Conversion of Example 3

The MTCS conversion according to Example 2 was carried out continuously for one day at an oven temperature of 950° C. The laboratory plant was subsequently made safe and cooled down, and the reactor tube was removed. Inspection of the tube revealed solid deposits which were metallically shiny in part and grey black in part and which were scraped off mechanically and analyzed. Altogether 3.5 g of solid material were collected. Elemental analysis gave the following result:

TABLE 3
Elemental composition of solid formed in MTCS conversion

| Element | [% by weight] |
|---|---|
| Si | 93.1 |
| Cl | 5.1 |
| Fe | 0.9 |
| Cr | 0.4 |
| Al | 0.2 |
| Ni | 0.1 |
| Na | 0.1 |

The carbon content of the sample could not be taken into account.

### Example 5

Hydrodehalogenation of STC to Hydrogen-Containing Chlorosilanes

The hydrodehalogenation of STC to give hydrogen-containing chlorosilanes was carried out in the reactor of Example 1. The reaction pressure involved was analogous to Example 2, and oven temperature was 950° C. The STC stream was 115 g/h for an H₂:STC amount of substance ratio of 4:1. Analysis of the product gas mixture by gas chromatography with regard to DCS, TCS, STC and HCl (calibration was done against corresponding pure substances) revealed the following result:

TABLE 4
Composition of product gas mixture for STC conversion

| Component | Content [% by weight] |
|---|---|
| DCS | 0.1 |
| TCS | 19.8 |
| STC | 75.2 |
| HCl | 4.9 |

### Example 6

Regenerating the Reactor by Removing the Solid Silicon Deposits

Experiment Example 4 was repeated initially to perform the MTCS conversion continuously for one day in the reactor. To get rid again of the deposited Si, STC was subsequently reacted with hydrogen in the reactor. Reaction pressure and oven temperature were similar to Example 5. The STC stream was 115 g/h for an H₂:STC amount of substance ratio of 4:1.

The STC fraction in the product gas was significantly lower than in Example 5 for a period of 20 h, similarly the HCl fraction during the initial 20 h was distinctly below the value of Example 5. The following result of GC analysis of the composition of the product gas mixture illustrates these facts.

TABLE 5
Composition of product gas mixture of STC conversion
after prior MTCS hydrogenation in same reactor

| Component | Content [% by weight] |
|---|---|
| DCS | 0.5 |
| TCS | 26.9 |
| STC | 70.1 |
| HCl | 2.5 |

The effect was of limited duration in that after t>25 h the known values of Example 5 were found again with regard to product gas composition.

Subsequent inspection of the reactor tube revealed a significant reduction in deposits of solid material. The amount of mechanically removable solid material was 0.5 g.

### LIST OF REFERENCE NUMERALS

(1) 1st reaction space
(2) 2nd reaction space
(3) Line for additional HCl
(4) Line for OCS, H₂
(5) Control valve system
(6) Line for product gas mixture
(7) Reaction space
(8) Line for OCS, H₂, additional HCl
(9) 1st reaction space
(10) 2nd reaction space
(11) Line for STC, H₂
(12) Line for product gas mixture containing additional HCl
(13) Line for OCS, optionally admixed with H₂

1. A process for producing a hydrogen-comprising chlorosilane in a pressurised reactor, comprising:
reacting at least one organochlorosilane with hydrogen in at least one reaction space of the pressurized reactor for at least part of the time,
wherein at least one of optionally two or more reaction spaces in which the reacting takes place is supplied with additional HCl for at least part of the time.

2. The process according to claim 1, further comprising:
reducing Si-based deposits of solid material during operation of the pressurised reactor.

3. The process according to claim 1,
wherein
the at least one reaction space each consists of a reactor tube comprising a gastight ceramic material, and
optionally at least one reactor tube is packed with packing elements comprising the gastight ceramic material.

4. The process according to claim 1, wherein the additional HCl
is supplied in a pure form or as a HCl-comprising gas mixture, or
is produced in the pressurised reactor by a chemical reaction other than the reacting.

5. The process according to claim 4,
wherein the chemical reaction producing the additional HCl is a hydrodehalogenation of silicon tetrachloride with hydrogen, which takes place in at least one of the optionally two or more reaction spaces of the pressurised reactor.

6. The process according to claim 1,
wherein
at least one of a feed gas comprising the at least one organochlorosilane, a feed gas comprising hydrogen, and the additional HCl is fed as a pressurised stream into the at least one reaction space of the pressurised reactor and reacted therein, by supply of heat, to form at least one product gas mixture comprising hydrogen-comprising chlorosilanes, and
the product gas mixture is led out of the pressurised reactor as another pressurised stream.

7. The process according to claim 1,
wherein
at least one, optionally every, reaction space is supplied alternatingly with the additional HCl and the at least one organochlorosilane in an admixture with hydrogen.

8. The process according to claim 7,
wherein
the additional HCl and the at least one organochlorosilane in an admixture with hydrogen are fed simultaneously to separate reaction spaces.

9. The process according to claim 7,
wherein
a time at which a switch between feeding the additional HCl and feeding the at least one organochlorosilane in an admixture with hydrogen to the at least one reaction space takes place is ascertained as a function of pressure, mass balance, or both, in the at least one reaction space.

10. The process according to claim 1,
wherein
the additional HCl, the at least one organochlorosilane, and hydrogen are fed simultaneously to one or more conjoint reaction spaces.

11. The process according to claim 10,
further comprising:
producing the additional HCl by hydrodehalogenation of silicon tetrachloride and hydrogen,
wherein
a molar ratio of silicon tetrachloride to a total amount of the at least one organochlorosilane is from 50:1 to 1:1,
a molar ratio of silicon tetrachloride to hydrogen is from 1:1 to 8:1, and
a molar ratio of the total amount of the at least one organochlorosilane to hydrogen is from 1:1 to 8:1.

12. The process according to claim 1,
wherein
the additional HCl is fed to at least one first reaction space,
the at least one organochlorosilane, optionally in an admixture with hydrogen, is fed to at least one second reaction space, and
a product gas mixture leaving the at least one first reaction space is fed to the at least one second reaction space.

13. The process according to claim 1,
wherein
the at least one organochlorosilane is selected from the group consisting of methyltrichlorosilane, methyldichlorosilane, propyltrichlorosilane, ethyltrichlorosilane and a mixture thereof.

14. The process according to claim 1,
wherein
the reacting occurs under at least one of the following conditions:
at a pressure of from 1 to 10 bar,
at a temperature of from 700 to 1000° C., and
with a gas stream having a residence time of from 0.1 to 10 s.

15. The process according to claim 1,
wherein
a product gas stream is sent for further processing or workup.

16. The process according to claim 3, wherein the gastight ceramic material is selected from the group consisting of SiC, Si₃N₄ and a hybrid system (SiCN) thereof.

17. The process according to claim 13, wherein the at least one organochlorosilane is methyltrichlorosilane.
